(19) United States
(12) Patent Application Publication
(10) Pub. No.: US 2012/0284666 A1
(43) Pub. Date: Nov. 8, 2012

(54) SEARCH PLATFORM WITH PICTURE SEARCHING FUNCITON

(76) Inventor: Wei-Lung Chiu, Taipei Hsien (TW)

(21) Appl. No.: 13/102,057

(22) Filed: May 6, 2011

(51) Int. Cl. G06F 3/048

(52) U.S. Cl. 715/810

(57) ABSTRACT

A search platform capable of displaying a frame on a display for searching data in a database; the database receiving uploading data; the search platform includes: at least one picture icon displaying on the frame to be as a search condition as a user selects the picture icon. A data is classified to the search condition as the data is uploaded to the database. The search platform further comprises texture icons displaying on the frame to be as a third search condition as a user selects the texture icon. Virtual images and practical images can be displayed on the frame. search platform of the present invention can search a database by selecting the picture icons as the search conditions. Thus an easier and direct searching method is provided to users. Furthermore, the knowledge about the names of an object can be neglected.

### FIELD OF THE INVENTION

The present invention relates to search platforms, and in particular to a search platform by that a user can select a picture icon for searching data.

### DESCRIPTION OF THE PRIOR ART

Due to the development of Internet, data and webpages are received rapidly by web users. As comparing with the prior art, currently, the amount of data received in a unit time is increased greatly. However, to much information causes the user cannot accept required data. Therefore, most users search data through search engines.

Internet search engine can search webpages or textures through networks. In searching, a user input texture as search conditions. Next, the engine compares the search conditions with search data. Then related data are displayed on a frame based on the similarity between the search condition and the search data. Thus method is used for a long time and thus it is still used in other forms of data searching.

For example, if the database of a teaching website stores various data. A user can search data by inputting textures so that the data or sub-webpage in the database can be found.

However it is possible that a user have no the professional knowledge about an object to be searched and does not know the professional names about the object, such as a camera, thus it is difficult for the user to input the textures for searching and thus he (or she) can not find the desired information.

### SUMMARY OF THE PRESENT INVENTION

Accordingly, the primary objective of the present invention is to provide a search platform with function of searching by pictures on a frame to have desired data, wherein data can be uploaded to a database and be classified by the picture icon; the data may be drawings, figures, textures, voices, images and web pages.

A search platform capable of displaying a frame on a display for searching data in a database; the database receiving uploading data; the search platform comprising: at least one picture icon displaying on the frame to be as a search condition as a user selects the picture icons; wherein a data is classified to one of search conditions as the data is uploaded to the database.

A texture icon can also be displayed on the frame to be as a third search condition as a user selects the texture icon. A data is classified to the third search condition as the data is uploaded to the database.

A virtual image or a practical image can be displayed on the frame; the first picture icon being on the virtual image or on the practical image.

The present invention device comprising a searching window for searching data based on the first search condition and displaying the data and the searching window may be a floating searching window. The first picture icon is a static picture icon or a video icon.

Moreover, the search platform divides the frame into different parts; and the parts being as the first picture icon.

As comparing with the prior art, the search platform of the present invention can search a database by selecting the picture icons as the search conditions. Thus an easier and direct searching method is provided to users. Furthermore, the knowledge about the names of an object can be neglected. Furthermore, when data is uploaded to a database, the search platform of the present invention can classify the data to related picture icons so as to neglect the process of data comparison in the prior art searching. Thus the speed of searching is increased.

### BRIEF DESCRIPTION OF THE DRAWINGS

FIG. 1A is a schematic view about the search platform of an embodiment of the present invention.

FIG. 1B is a schematic view showing the search operation based on the structure in FIG. 1A.

FIG. 1C is a schematic view showing the search platform after the search operation.

FIG. 1D is a schematic view showing another search operation based on the search platform shown in FIG. 1A.

FIG. 2 is a schematic view showing the search platform in another embodiment of the present invention.

FIG. 3 is a schematic view showing the search platform in a further embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

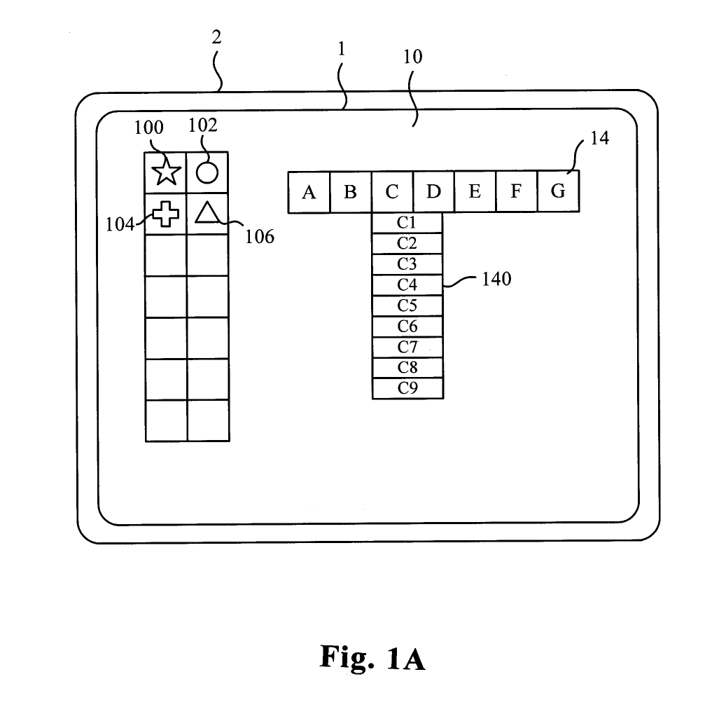

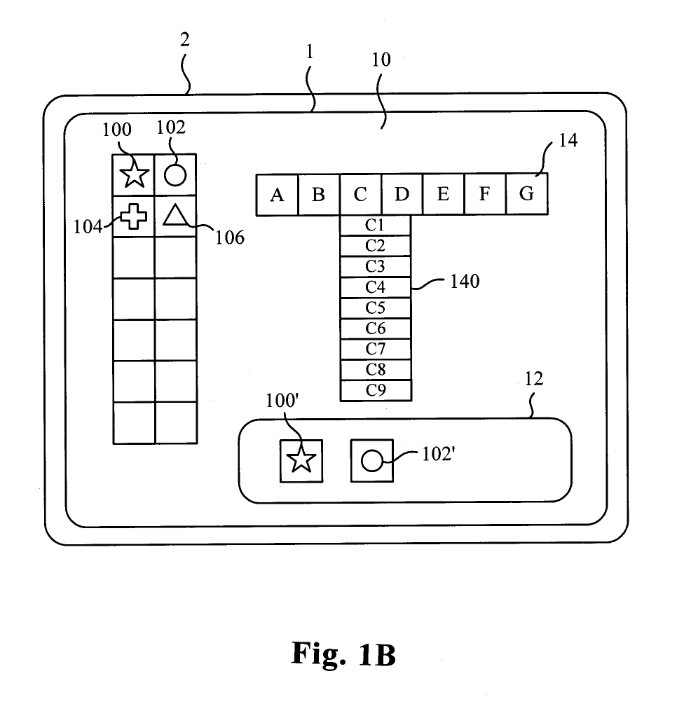

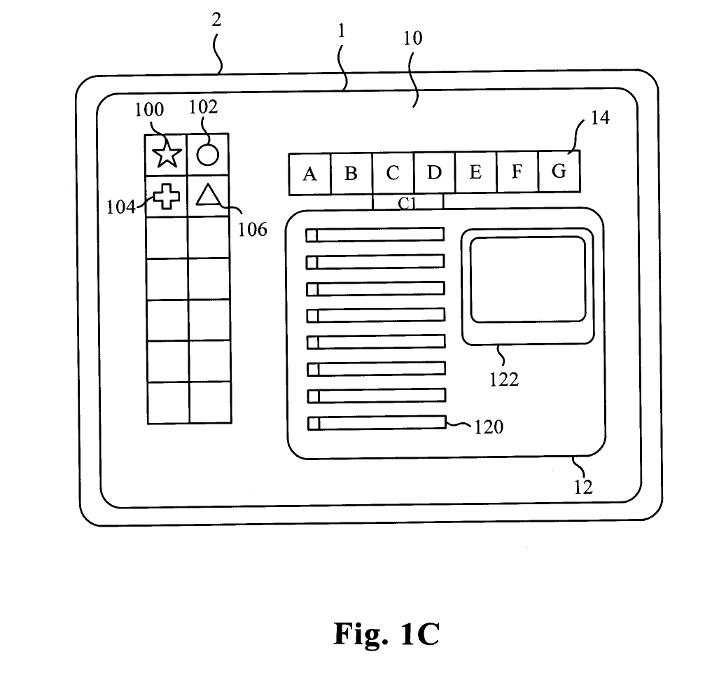

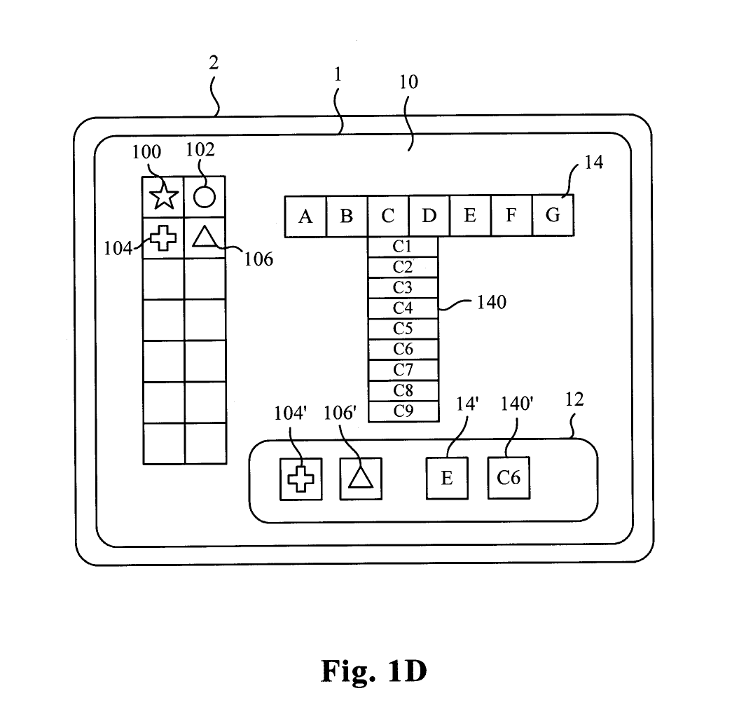

Referring to FIGS. 1A, a schematic view about the search platform of the present invention is illustrated.

In the present invention, the search platform 1 causes a frame 10 to be displayed on a display 2. The frame 10 has a first picture icon 100 and a second picture icon 102.

In the present invention, the first picture icon 100 is a button to be selected by clicking a left button in a mouse. Similarly, the second picture icon 102 is a button to be selected by clicking a left button of a mouse. The selection of the first picture icon 100 or a second picture icon 102 represents that a first search condition or a second search condition, respectively, is selected.

Referring to FIG. 1B, a schematic view about the search on the search platform is illustrated. In FIG. 1B, when the first picture icon 100 and the second picture icon 102 is selected, a floating searching window 12 (like a dialog box) is shown in the frame 10. The floating searching window 12 displays a first search condition 100′ from the selection of the first picture icon 100 and the second picture icon 102 from the selection of the second picture icon 102. Generally, a drawing of the first search condition 100′ is identical to or similarly to that of the first picture icon 100 and the drawing of the second picture icon 102 is identical to or similarly to that of the second picture icon 102.

Referring to FIG. 1C, after asserting the search conditions and a search operation is performed, the searching results are displayed on the floating searching window 12. In the present invention, the searching results are displayed by a listing table 120. An item in the listing table 120 can be shown by drawings or data 122.

Referring to FIGS. 1A and 1D, FIG. 1D is a schematic view about the search of the search platform 1. As illustrated in FIG. 1A and 1D, in this embodiment, the search platform 1 further includes a third picture icon 104 and a fourth picture icon 106. Similarly, if the third picture icon 104 is selected, a third search condition 104′ is shown and if the fourth picture icon 106 is selected, a fourth search condition 106′ is shown. However in this embodiment, there are fourth picture icons are provided. However this is not used to confine the scope of the present invention. The number of the picture icon is not limited in the present invention.

Besides, as illustrated in FIG. 1A, in the frame 10 of the search platform 1, there are a plurality of texture icons 14. Besides, as a texture icon 14 is selected, a plurality of sub-texture icons 140 are provided. Thus, to select the texture icon 14 and the sub-texture icon 140 will provide a fifth search condition 14′ and a sixth search condition 140′, as illustrated in FIG. 1D.

In above mentioned embodiment, the search platform 1 is connected to databases. When a user selects different search conditions, the search platform 1 searches related data in the databases according to the search conditions selected. It should be noted that in the present invention, the selected search conditions are used as a classifier, instead of as a data for comparison. The searching way of the present invention will be illustrated hereinafter.

The user can upload data to above mentioned database. The uploaded data can be at least one of drawing files, texture files, voice files, image files, web-pages, message files, and other digital contents. When a user uploads data to the databases, the picture icons and texture icons shown in the search platform 1 can be used as a classifier for classifying the upload data.

For example, when a teacher uploads data about the teaching contents to a study website . The teacher can firstly assure that which icons on the search platform 1 is related to the uploading data. Thus the uploaded data can be classified based on the related icons and thus these related icons are also the search conditions of this uploading conditions. For example, the teaching data about atoms is related to a picture icon having a shape of an atom and a texture icon having a texture of “atom”. Thus when a user selects these two icons, this teaching data can be searched. The classification of the uploading data is unlimited in the present invention. For example, an uploading data can classify to a first picture icon, a third picture icon and a texture icon. Then a user selects anyone of these three icons, the uploading data can be found.

As above mentioned, the search platform 1 of the present invention classifies data as the data is uploaded. Therefore, when a user selects a picture icon or a texture icon, the search platform 1 sets the selected picture icon and texture icon as search conditions, and the data classified to these picture icon and texture icons are found. Thus the step of data comparison is neglected and thus the speed of searching is speeded.

Since above mentioned picture icons are used as classifiers, to cause a user can easily identify the search condition or to have a precise searching result, the appearance of the picture icon can be designed to be very similar to the search condition. For example, in above example of atoms, the picture icon is designed to have an appearance of an “atom” so as to inform the user that this icon is related to data of “atom”.

Besides, an appearance of a picture icon presents different visual effects based on the requirement of users. For example, in above mentioned picture icon of atoms, it can be presented with a video icon, that is, an electron rotates around a nuclei.

As illustrated in FIG. 1A, the first picture icon 100, second picture icon 102, third picture icon 104, fourth picture icon 106, the texture icon 14 and the sub-texture icons 140 can be arranged in sub-frames by dividing the frame 10 in to a plurality of sub-frames by a system manager. Next, uploading data can be classified based on picture icons and the texture icons. Then, a user can select the picture icon and texture icon so as to search data in the database. Therefore, the search platform 1 of the present invention can be used in digital learning, network forum, tool or machine using guides, menu for playing games, or web-page transferring, etc.

For example, for learning web-pages for game, features in the game, such as people, related objects and sceneries, operation ways, etc. can be captured from the software of the game. Then these features are set as icons and are listed on a frame and the frame is displayed on a display screen. Then all the people appeared in the game are interconnected to the icon of the people. Other objects in the game are also connected to related icons. However all the objects in the game are not retained in the original form without changing positions and status in the game. A user can search an object in the game from the frame and thus known the ways for playing the game.

Other than above mentioned virtual object, the present invention also suitable for practical objects.

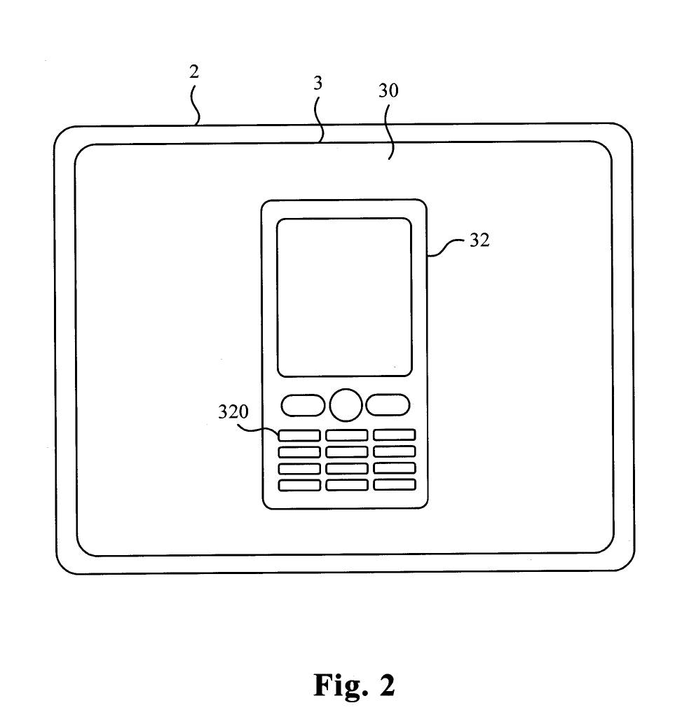

Referring to FIG. 2, another search platform 3 according to the present invention is illustrated. Similarly, the search platform 3 shows a frame 30 on a display 2. The frame 30 shows images 32 for practical objects 32. In this example, the practical object 32 is a multi-functional handset.

The different part of the practical image 32 is set as picture icons 320, as illustrated in FIG. 2. The data about the uses and other special applications about the parts of the practical image 32 are uploaded to a database and these data are classified based on the picture icons 320. For example, if one picture icon 320 on the practical image 32 is a control key of satellite navigation. Then the user can upload movies of satellite navigation about this handset to the database and these movies are classified to the picture icon 320 of satellite navigation. Then if a user searches this picture icon 320, all these movies can be found.

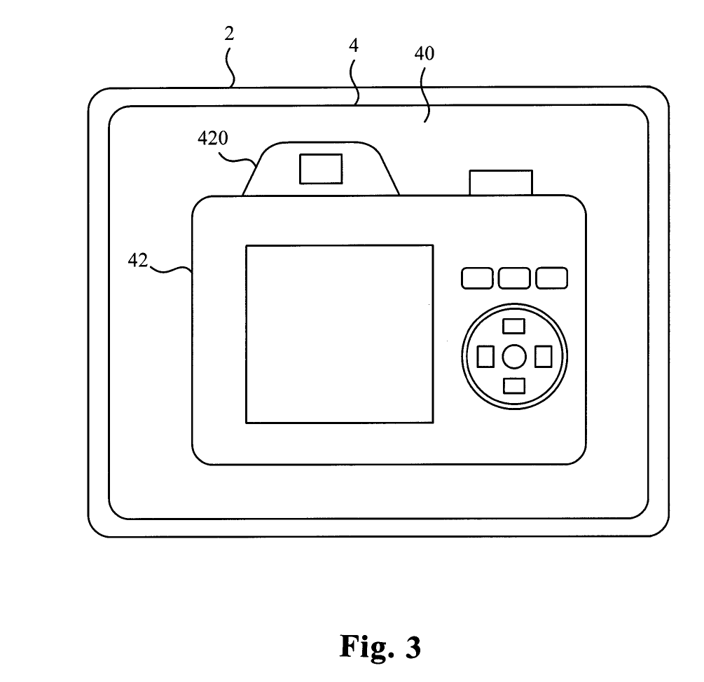

Besides, referring to FIG. 3, a schematic view about a search platform 4 according to another embodiment of the present invention is illustrated. Similarly, the search platform 4 shows a frame 40 on a display 2. The frame 40 shows images for practical objects 42. In this example, the practical object 42 is a digital camera.

In this embodiment, the different part of the practical image 42 is set as picture icons 420, as illustrated in FIG. 3. Like the embodiment shown in FIG. 2, the data about the uses and other special applications about the parts of the practical image 42 are uploaded to a database and these data are classified based on the picture icons 420. A user can select the desired picture icons 420 so as to search the data about the different units in the digital camera to understand the function and application of the camera.

Other than uploading texture files or image files about the uses and applications of a multifunctional handsets and digital cameras, the search platform can connect a discussion area to a picture icon. Thus the user can select the picture icon and thus it is connected to the discussion area for getting more information. Similarly, the picture icon can be built in the default function of the discussion area. Thus the difficult in searching due to the knowledge of the names of an object can be avoided.

For example, even the user does not know the name of a unit of a digital camera, the user can search the desired information from the practical image by selecting the unit shown in the image. Moreover, when a user asks a question in the discussion area, the article of the user can have the image of the picture icon so that other users can understand the key point of the article based on the appearance of the picture icon.

As comparing with the prior art, the search platform of the present invention can search a database by selecting the picture icons as the search conditions. Thus an easier and direct searching method is provided to users. Furthermore, the knowledge about the names of an object can be neglected. Furthermore, when data is uploaded to a database, the search platform of the present invention can classify the data to related picture icons so as to neglect the process of data comparison in the prior art searching. Thus the speed of searching is increased.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A search platform capable of displaying a frame on a display for searching data in a database; the database receiving uploading data; the search platform comprising:
a first picture icon displaying on the frame to be as a first search condition as a user selects the first picture icon;
wherein a data is classified to the first search condition as the data is uploaded to the database.

2. The search platform as claimed in claim 1, further comprising:
a second picture icon displaying on the frame to be as a second search condition as a user selects the second picture icon;
wherein a data is classified to the second search condition as the data is uploaded to the database.

3. The search platform as claimed in claim 1, further comprising;
a texture icon displaying on the frame to be as a third search condition as a user selects the texture icon;
wherein a data is classified to the third search condition as the data is uploaded to the database.

4. The search platform as claimed in claim 1, further comprising:
a virtual image displaying on the frame; the first picture icon being on the virtual image.

5. The search platform as claimed in claim 1, further comprising:
a practical image displaying on the frame, and the first picture icon is on the practical image.

6. The search platform as claimed in claim 1, further comprising:
a searching window for searching data based on the first search condition and displaying the data.

7. The search platform as claimed in claim 6, wherein the searching window is a floating searching window.

8. The search platform as claimed in claim 1, wherein the first picture icon is a static picture icon.

9. The search platform as claimed in claim 1, wherein the first picture icon is a video icon.

10. The search platform as claimed in claim 1, wherein the search platform divides the frame into different parts; and the parts being as the first picture icon.
